(19) United States
(12) Patent Application Publication
(10) Pub. No.: US 2026/0176504 A1
(43) Pub. Date: Jun. 25, 2026

(54) ECO-FRIENDLY THERMALLY CONDUCTIVE ADHESIVE AND METHOD FOR PRODUCING SAME

(71) Applicant: FOUNDATION OF SOONGSIL UNIVERSITY-INDUSTRY COOPERATION, Seoul (KR)

(72) Inventors: Kiwon EUM, Seoul (KR); Seungyeon KIM, Seoul (KR); Gyuri SHIN, Seoul (KR); Sol HAN, Hanam-si, Gyeonggi-do (KR); Jina PARK, Seoul (KR); Jinsung PARK, Bucheon-si, Gyeonggi-do (KR); Youngho YOO, Goyang-si, Gyeonggi-do (KR)

(73) Assignee: FOUNDATION OF SOONGSIL UNIVERSITY-INDUSTRY COOPERATION, Seoul (KR)

(21) Appl. No.: 19/124,295

(22) PCT Filed: Apr. 18, 2023
(86) PCT No.: PCT/KR2023/005201

§ 371 Date: Apr. 25, 2025

(30) Foreign Application Priority Data
Nov. 29, 2022 (KR) 10-2022-0163054
Feb. 1, 2023 (KR) 10-2023-0013582

(51) Int. Cl. C09J 9/02; C09J 7/22

(52) U.S. Cl. CPC C09J 9/02; C09J 7/22; C09J 2301/302; C09J 2301/408

(57) ABSTRACT

A method of manufacturing an eco-friendly thermally conductive adhesive, includes: a first step of mixing zinc oxide and water to prepare an aqueous zinc oxide solution, and sequentially adding zinc acetate, water, urea, and a defoamer to the aqueous solution followed by stirring to prepare a first mixture; a second step of sequentially adding casein protein and a base aqueous solution to the first mixture followed by stirring to prepare a second mixture; a third step of adding ammonia water to the second mixture and then raising temperature followed by stirring to prepare a third mixture; and a fourth step of adding conductive graphite and a dispersant to the third mixture, followed by stirring and cooling.

### TECHNICAL FIELD

The present disclosure relates to an eco-friendly thermally conductive adhesive and a manufacturing method thereof.

### BACKGROUND ART

The primary requirement for an adhesive for flooring materials is adhesion with the concrete floor and wood as the flooring material, and it must be designed in an eco-friendly manner as it is a process that is carried out indoors.

Conventional adhesive compositions for flooring materials have been used only to bond the floorboard material to the concrete floor, and these adhesives contain organic solvents, which are released into the air to cause adverse effects to operators. In addition, effects of the adhesive remain even after installation of the flooring, which has created a new term “new house syndrome” in recent years. Later, due to these issues, water-soluble adhesives or solvent-free adhesives have been released and now widely used, but these adhesives also simply serve as adhesives with no effect of compensating for the shortcomings of wood or preventing noise between floors in the buildings.

On the other hand, the conventional method to prevent noise between floors is to use a sound-absorbing material attached to the floorboard, or conversely, to attach a sound-absorbing material to the floor and then the floorboard. However, these methods increased the cost due to the additional process of using adhesives, with many disadvantages in terms of construction. In addition, most of the adhesives used to attach sound-absorbing materials involve the use of solvent-type adhesives, so they still have the problem of releasing organic solvents.

Second, another way to prevent noise between floors was to use a hollow filler instead of sound-absorbing materials. Such the method may achieve suppression of noise between floors due to the characteristics of the hollow filler, but the low thermal conductivity, which is a disadvantage of the hollow filler, caused a problem in combination with wood with low thermal conductivity, that it reduces overall thermal conductivity of the flooring material.

Therefore, there is a growing need for an eco-friendly adhesive composition for flooring materials that does not release organic solvents while maintaining adhesion intact compared to conventional adhesives.

In addition, unlike conventional adhesives, there is a growing need for an adhesive composition for flooring materials that exhibits excellent adhesion without an additional process and can reduce heating costs in winter by improving low thermal conductivity, which has been known to be a disadvantage of wood flooring materials.

Meanwhile, there is a need for an adhesive composition for flooring materials that is eco-friendly and has a low risk of causing diseases to human body since no harmful substances are released by using the product in dilution with water for the convenience of operations.

### DISCLOSURE OF THE INVENTION

### Technical Goals

An object of the present disclosure is to provide a method of manufacturing an eco-friendly thermally conductive adhesive that exhibits thermal conductivity and is harmless to the human body.

In addition, another object of the present disclosure is to provide an eco-friendly thermally conductive adhesive manufactured in accordance with the manufacturing method.

### Technical Solutions

In order to achieve the above object, the present disclosure provides a method of manufacturing an eco-friendly thermally conductive adhesive, including a first step of mixing zinc oxide and water to prepare an aqueous zinc oxide solution, and sequentially adding zinc acetate, water, urea, and a defoamer to the aqueous solution followed by stirring to prepare a first mixture; a second step of sequentially adding casein protein and a base aqueous solution to the first mixture followed by stirring to prepare a second mixture; a third step of adding ammonia water to the second mixture and then raising temperature followed by stirring to prepare a third mixture; and a fourth step of adding conductive graphite and a dispersant to the third mixture, followed by stirring and cooling.

In addition, the present disclosure provides an eco-friendly thermally conductive adhesive manufactured by the manufacturing method.

### Advantageous Effects

An eco-friendly thermally conductive adhesive manufactured according to the present disclosure not only minimizes energy loss by increasing an efficiency of residential heating when used as an adhesive for flooring materials because it exhibits heat conductivity by containing carbon fillers, but also is harmless to the human body of workers and users as the release of volatile organic compounds (VOCs) that cause environmental pollution is remarkably suppressed as it is manufactured with sodium caseinate in replace of harmful components in conventional adhesives.

### BRIEF DESCRIPTION OF DRAWINGS

FIG. 1 shows a graph represented by measuring a thermal conductivity coefficient of an adhesive according to an embodiment of the present disclosure.

FIG. 2 shows result data of HS-GC/MS library analysis on the content of volatile organic compounds (VOCs) contained in an adhesive manufactured according to an embodiment of the present disclosure.

### BEST MODE FOR CARRYING OUT THE INVENTION

Hereinafter, the present disclosure will be described in detail.

The present inventors have completed the present disclosure by preparing an eco-friendly thermally conductive adhesive that not only minimizes energy loss by increasing the efficiency of residential heating when used as an adhesive for flooring materials because it shows thermal conductivity by including carbon fillers, but also is harmless to the human body of workers and users as the release of volatile organic compounds (VOCs) that cause environmental pollution is remarkably suppressed as it is manufactured with sodium caseinate in replace of harmful components in conventional adhesives.

The present disclosure provides a method of manufacturing an eco-friendly thermally conductive adhesive, including a first step of mixing zinc oxide and water to prepare an aqueous zinc oxide solution, and sequentially adding zinc acetate, water, urea, and a defoamer to the aqueous solution followed by stirring to prepare a first mixture; a second step of sequentially adding casein protein and a base aqueous solution to the first mixture followed by stirring to prepare a second mixture; a third step of adding ammonia water to the second mixture and then raising temperature followed by stirring to prepare a third mixture; and a fourth step of adding conductive graphite and a dispersant to the third mixture, followed by stirring and cooling.

The zinc oxide and zinc acetate are insoluble agents that improve resistance to water, dissociate in water, and exist in the form of zinc ions, so as to allow the adhesive to maintain its adhesion strength even in contact with water by binding to two carboxyl groups in the casein protein.

The urea plays a role of a fluidizer that improves the fluidity of the adhesive, and when applied, the adhesive gives fluidity as it is in a liquid form, allowing the adhesive to penetrate into every part of a substrate.

The defoamer may play a role in removing foam generated during the stirring process in the manufacture of the adhesive.

In the second step, the casein protein may be prepared by agglomeration by adding acids including vinegar, citric acid, lactic acid, glycolic acid, oxalic acid, malic acid, succinic acid, or a combination thereof to the milk.

The casein protein may be prepared by agglomeration in a pH range of 4˜6.

The milk may include low-fat milk, non-fat milk, or a combination thereof.

In the second step, the base may include sodium bicarbonate, borax, lime, ammonium carbonate, or a combination thereof.

In particular, the sodium bicarbonate may serve as a neutralizing agent to neutralize casein proteins extracted by adding acid to milk.

In the third step, ammonia water may play a role in dissolving casein protein with an alkaline reagent.

In addition, in the third step, the temperature may be raised to 50˜100° C. and stirring may be performed for 5˜30 minutes.

The content of the conductive graphite may account for 2˜5 wt % of the third mixture, and the conductive graphite may give thermal conductivity to the adhesive according to the present disclosure.

In the fourth step, cooling may be performed to 30˜40° C. and stirring is performed for 10˜30 minutes.

After the fourth step, the method may further include adding a flavor and then cooling to room temperature.

Specifically, the flavor may be a vanilla flavor and serve to mitigate odors, but is not limited to.

In addition, the present disclosure provides an eco-friendly thermally conductive adhesive manufactured by the manufacturing method.

A tensile shear adhesion strength of the adhesive may be greater than or equal to 0.987 N/mm², and a thermal conductivity may be greater than or equal to 0.84 W/m·k.

### MODES FOR CARRYING OUT THE INVENTION

Hereinafter, the present disclosure will be described in more detail through examples. These examples are merely intended to describe the present disclosure more specifically, and it will be apparent to those with ordinary skill in the art to which the present disclosure pertains that the scope of the present disclosure is not limited by these examples according to the gist of the present disclosure.

### <Manufacturing Example 1> Manufacture of Eco-Friendly Thermally Conductive Adhesive

### 1.1 Extraction of Casein Protein

1 L of non-fat milk was heated by low heat application until formation of a film and air bubbles on the edges. The heating was stopped, and then 38 mL of vinegar was added with stirring to form a lump. At this time, given that a pH of milk was 6.6 and that of vinegar 3.0, the amount of vinegar to make the target pH of the mixture 4.6 was calculated in advance and then added. A pH meter was inserted to check if the pH reached 4.6, and if not, more vinegar was added for adjustment. After cooling at room temperature, the casein protein in solid form was extracted by straining through a cotton cloth. The casein protein was dried in a cool, dry place. The mass of a container (vial) to contain the dried casein protein was measured and recorded. The dried casein protein was transferred to a pre-massed vial, and the mass was measured and recorded. The mass of the extracted pure casein protein was obtained and recorded.

### 1.2 Manufacture of Eco-Friendly Thermally Conductive Adhesive

0.75 g of water and 0.75 g of zinc oxide were placed in a beaker, and 1.5 g of aqueous zinc oxide solution in 50 wt % was prepared. 1.5 g of zinc acetate was added to the beaker, 45 mL of distilled water was added and stirred. Afterwards, 25 g of urea was added to the beaker, and once foamed, 2 drops (0.05 mL) of defoamer were added and stirred continuously. When all the ingredients that were sequentially added to the beaker were dissolved, 30 g of casein protein was added. Afterwards, 34.5 mL of aqueous solution of sodium bicarbonate, prepared by mixing 13.8 g of sodium bicarbonate and 20.7 g of water, was added and stirred for 10 minutes. 1.7 mL of ammonia water was slowly added dropwise, and the temperature was increased to 80° C., followed by stirring for 10 minutes. Afterwards, 4.18 g (3 wt %) of conductive graphite was added, 0.7 g (0.5 wt %) of dispersant was added, and then the mixture was stirred at 80° C. for 15 minutes and cooled to 40˜50° C. Two drops (0.05 mL) of vanilla flavor were added to reduce odor. After cooling at room temperature, it was transferred to a soft container to complete the 3% conductive graphite adhesive.

### <Comparative Example 1> Manufacture of Adhesive which does not Contain Conductive Additive

With the exception of the addition of conductive graphite, the adhesive was prepared in the same way as in Example 1.

### <Experimental Example 1> Test for Tensile Shear Adhesion Strength of Adhesive

In order to measure the physical properties of the adhesive (Koptri-22-08-13777-1) manufactured according to the Example, the tensile shear adhesion strength was measured using UTM instrument by requesting to the Korea Polymer Testing & Research Institute, the results of which are shown in Table 1 below.

### *Test Conditions and Notes

(1) Test speed: 1.3 mm/min
(2) Average result value of 5 runs
(3) All 5 runs resulted in a break at an adhesive surface of a sample.

TABLE 1

| Sample name | Test items | Unit | Test method | Test result |
|---|---|---|---|---|
| Koptri-22-08-13777-1 | Tensile shear | N/mm² | Measured with | 0.987 |
| | adhesion strength | | UTM instrument | |

Referring to Table 1 above, it was found that the adhesive prepared according to the Example has a tensile shear adhesion strength of 0.987 N/mm², which is superior to the conventional adhesive (tensile shear adhesion strength: 0.8 N/mm²).

### <Experimental Example 2> Measurement of Thermal Conductivity of Adhesive

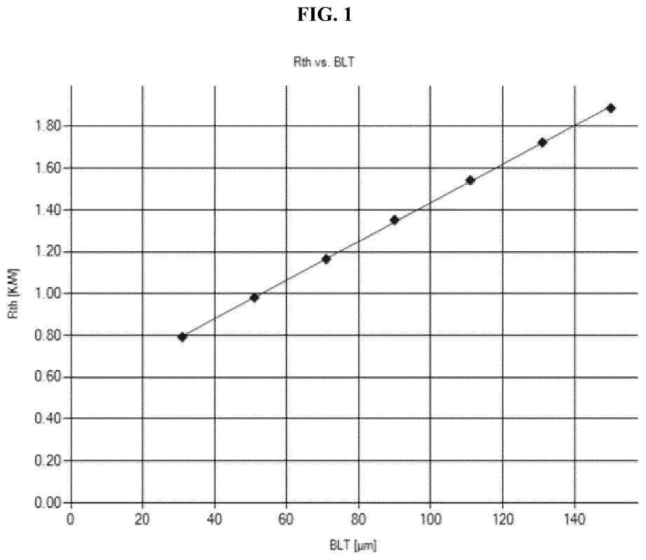

For the adhesive prepared according to the Example above, the thermal conductivity meter (Kemthem QTM-D3 product, Japan) was used to measure the thermal conductivity, the results of which are shown in FIG. 1 below.

Referring to FIG. 1, the thermal conductivity coefficient of the adhesive according to the Example of the present disclosure is 0.84 W/(m·K), which is higher than the thermal conductivity coefficient (0.66 W/(m·K)) of the existing general acrylic adhesive with the thermal conductivity, such that it was noticed that it has the effect of minimizing energy loss by increasing the efficiency of residential heating when used as an adhesive for flooring.

### <Experimental Example 3> Analysis of Harmful Components of Adhesive

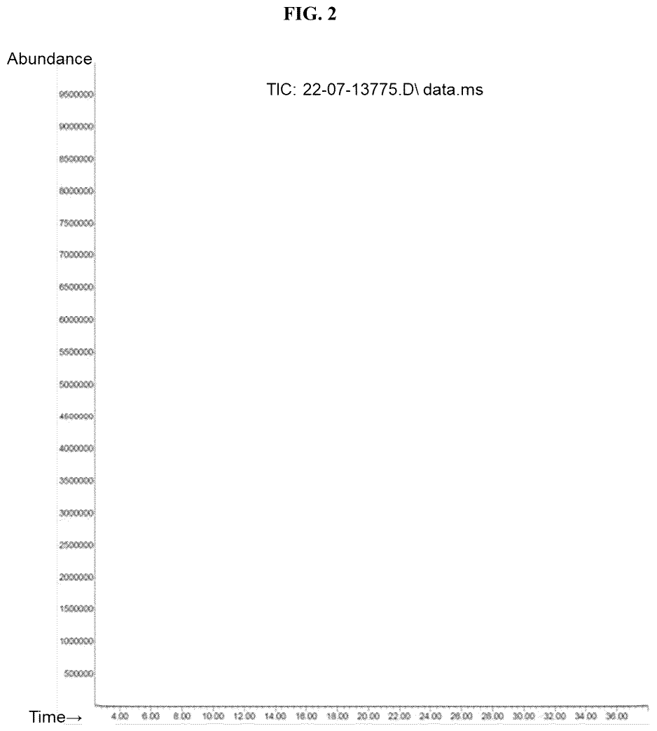

The content of volatile organic compounds (VOCs) contained in the adhesive prepared according to the Example was analyzed by the HS-GC/MS library, proceeded by requesting to the Korea Polymer Testing & Research Institute for the content of the volatile organic compounds, the results of which are shown in the following FIG. 2 and Table 2.

### *HS-GC/MS (Headspace—Gas Chromatograph/Mass Spectrometer) Instrument Conditions

(1) Measurement instrument: PerkinElmer TurboMatrix HS40+Agilent GC-MS system
(2) Headspace conditions
(2-1) Koptri-SW0.2
(2-2) Heating temperature: 50° C.
(2-3) Heating time: 30 min
(3) GC/MS Test conditions
(3-1) Column: ZB-624
(3-2) Carrier Gas: He, 3.0 mL/min
(3-3) Ionization method: El mode (70 eV)
(3-4) Range of molecular weight: Scan mode (30-550 m/z)
   <Content of Volatile Organic Compounds; Unit μg/m³>

TABLE 2

| Category | Example |
|---|---|
| Formaldehyde | Undetected |
| Toluene | Undetected |
| Total volatile organic compounds | Undetected |

Referring to Table 2, formaldehyde, toluene, and total volatile organic compounds were not detected in the adhesive according to the Example, and as shown in the Table 2, the adhesive according to the Example had significantly suppressed emission of volatile organic compounds (VOCs) that cause environmental pollution compared to the conventional adhesive, finding harmlessness to the human body of the worker and the user.

While a specific part of the present disclosure has been described in detail above, it is clear for those skilled in the art that this specific description is merely preferred example embodiments, and the scope of the present disclosure is not limited thereby. Thus, the substantial scope of the present disclosure is defined by the appended claims and their equivalents.

1. A method of manufacturing an eco-friendly thermally conductive adhesive, the method comprising:
a first step of mixing zinc oxide and water to prepare an aqueous zinc oxide solution, and sequentially adding zinc acetate, water, urea, and a defoamer to the aqueous solution followed by stirring to prepare a first mixture;
a second step of sequentially adding casein protein and a base aqueous solution to the first mixture followed by stirring to prepare a second mixture;
a third step of adding ammonia water to the second mixture and then raising temperature followed by stirring to prepare a third mixture; and
a fourth step of adding conductive graphite and a dispersant to the third mixture, followed by stirring and cooling.

2. The method of claim 1, wherein, in the second step, the casein protein is prepared by agglomeration by adding acids comprising vinegar, citric acid, lactic acid, glycolic acid, oxalic acid, malic acid, succinic acid, or a combination thereof to milk.

3. The method of claim 2, wherein the casein protein is prepared by agglomeration in a pH range of 4˜6.

4. The method of claim 2, wherein the milk comprises low-fat milk, non-fat milk, or a combination thereof.

5. The method of claim 1, wherein, in the second step, the base comprises sodium bicarbonate, borax, lime, ammonium carbonate, or a combination thereof.

6. The method of claim 1, wherein, in the third step, the temperature is raised to 50˜100° C. and stirring is performed for 5˜30 minutes.

7. The method of claim 1, wherein a content of the conductive graphite accounts for 2˜5 wt % of the third mixture.

8. The method of claim 1, wherein, in the fourth step, cooling is performed to 30˜40° C. and stirring is performed for 10˜30 minutes.

9. The method of claim 1, further comprising:
after the fourth step, adding a flavor and then cooling to room temperature.

10. An eco-friendly thermally conductive adhesive manufactured by the manufacturing method according to claim 1.

11. The eco-friendly thermally conductive adhesive of claim 10, wherein a tensile shear adhesion strength of the adhesive is greater than or equal to 0.987 N/mm², and a thermal conductivity is greater than or equal to 0.84 W/m·k.
